(19) United States
(12) Patent Application Publication
(10) Pub. No.: US 2024/0383368 A1
(43) Pub. Date: Nov. 21, 2024

(54) Battery-Exchange System and Service Station

(71) Applicant: Ample, Inc., San Francisco, CA (US)

(72) Inventors: Alexander Craig Kundrot, San Francisco, CA (US); Kenji Bowers, San Francisco, CA (US)

(21) Appl. No.: 18/318,001

(22) Filed: May 16, 2023

(51) Int. Cl. B60L 53/80; B60L 53/36

(52) U.S. Cl. CPC B60L 53/80; B60L 53/36

(57) ABSTRACT

A system for exchanging electric-vehicle batteries. The system includes a vehicle lift having a platform that supports and lifts an electric vehicle from a lowered position to a raised position, the platform length measured with respect to a first axis. The platform has a service hole to expose an underside of the electric vehicle. Tracks pass below the platform and into a service cavity defined by the vehicle lift when the platform is in the raised position. The tracks extend along a second axis that is orthogonal to the first axis. A battery-exchange robot includes a base mounted on the tracks, a battery receptacle configured to hold one or more batteries, and a telescoping arm attached to the base and the battery receptacle, the telescoping arm configured to extend and contract with respect to the first axis to position the battery receptacle with respect to the underside of the vehicle.

### TECHNICAL FIELD

This application relates generally to battery-exchange systems for electric vehicles.

### BACKGROUND

Electric vehicles have limited range and battery life and periodically need additional electrical energy. When the electric-vehicle batteries are low or depleted, they are traditionally recharged by physically coupling an electrical charger to a charge port on the vehicle. Even with rapid charging, it takes at least 30 minutes to partially recharge the batteries. Another approach is to exchange the depleted batteries with charged batteries. Battery swapping can be performed in minutes, but additional infrastructure and technology are needed.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

An aspect of the invention is directed to a system for exchanging electric-vehicle batteries, comprising a vehicle lift having a platform that supports and lifts an electric vehicle from a lowered position to a raised position, the platform having a length measured with respect to a first axis, the platform having a service hole to expose an underside of the electric vehicle; tracks that pass below the platform and into a service cavity defined by the vehicle lift when the platform is in the raised position, the tracks extending along a second axis that is orthogonal to the first axis, the first and second axes orthogonal to a vertical axis along which the platform is raised and lowered; and a battery-exchange robot. The battery-exchange robot comprises a base mounted on the tracks; a battery receptacle configured to hold one or more batteries; and a telescoping arm attached to the base and the battery receptacle, the telescoping arm configured to extend and contract with respect to the first axis to position the battery receptacle with respect to the underside of the vehicle.

In one or more embodiments, the system further comprises a battery-storage apparatus, the tracks extending to the battery storage apparatus. In one or more embodiments, the battery-exchange robot is configured to receive and transport one or more depleted batteries from the electric vehicle to the battery-storage apparatus. In one or more embodiments, the battery-exchange robot is configured to and transport one or more charged batteries from the battery-storage apparatus to the electric vehicle. In one or more embodiments, the one or more depleted batteries and the one or more charged batteries are enclosed in respective battery trays.

In one or more embodiments, the battery receptacle comprises a cover; a housing defining a cavity; and a motorized battery holding device in the cavity. In one or more embodiments, the motorized battery holding device includes a plurality of robotic grippers, each robotic gripper configured to releasably hold a side of a battery tray that includes the one or more batteries. In one or more embodiments, each robotic gripper includes a respective planar surface, the battery tray includes planar sides, and the respective planar surface of each robotic gripper mechanically engages one of the planar sides of the battery tray. In one or more embodiments, the robotic grippers are arranged into a plurality of robotic-gripper pairs, each robotic-gripper pair includes first and second robotic grippers that are configured to mechanically engage neighboring sides of the battery tray, a respective corner of the battery tray between the first and second robotic grippers of each robotic-gripper pair, first and second robotic-gripper pairs are slidably mounted on a first rail, third and fourth robotic-gripper pairs are slidably mounted on a second rail, the first and second rails extending parallel to the first axis, and respective positions of the first, second, third, and fourth robotic-gripper pairs with respect to the first axis are variable.

In one or more embodiments, the first and second rails are slidably mounted on a center rail that extends parallel to the second axis, the respective positions of the first and second robotic-gripper pairs with respect to the second axis are variable by moving the first rail along the center rail, and the respective positions of the third and fourth robotic-gripper pairs with respect to the second axis are variable by moving the second rail along the center rail. In one or more embodiments, the motorized battery holding device further includes a motorized lift to raise and lower the first, second, and center rails to thereby raise and lower the robotic grippers. In one or more embodiments, the cover has a default closed state, the cover configured to transition to an opened state in order for the battery receptacle to remove the battery tray from the vehicle or to provide the battery tray to the vehicle.

Another aspect of the invention is directed to an electric-vehicle service station comprising a vehicle lift having a platform and a plurality of motorized lifts that raise and lower the platform, the platform having an adjustable length, measured with respect to a first axis, to support electric vehicles of different sizes, the platform having a service hole to expose an underside of the electric vehicle; an upwardly sloped on-ramp disposed between ground level and the platform; a downwardly sloped off-ramp disposed between the platform and ground level; tracks that pass below the platform and into a service cavity defined by the vehicle lift when the platform is in a raised position, the tracks extending along a second axis that is orthogonal to the first axis, the first and second axes orthogonal to a vertical axis along which the platform is raised and lowered; a battery-storage apparatus, the tracks extending to the battery storage apparatus; and a battery-exchange robot mounted on the tracks. The battery-exchange robot is configured to receive one or more depleted batteries from the underside of the electric vehicle and transport the one or more depleted batteries to the battery-storage apparatus to be charged, and receive one or more charged batteries from the battery-storage apparatus and transport the one or more charged batteries to the underside of the electric vehicle.

In one or more embodiments, the battery-exchange robot comprises a base mounted on the tracks; a battery receptacle that holds, at different times, the one or more depleted batteries and the one or more charged batteries; and a telescoping arm attached to the base and the battery receptacle, the telescoping arm configured to extend and contract with respect to the first axis to position the battery receptacle with respect to the underside of the vehicle. In one or more embodiments, the battery receptacle comprises a cover; a housing defining a cavity; and a motorized battery holding device in the cavity, the motorized battery holding device includes a plurality of robotic grippers that releasably hold an electric-vehicle battery.

In one or more embodiments, the motorized battery holding device further comprises a plurality of pedestals that support the electric-vehicle battery; and a plurality of pressure sensors, each pressure sensor disposed on a respective pedestal. In one or more embodiments, the motorized battery holding device further comprises a motorized battery lift that raises and lowers the robotic grippers towards and away from the underside of the vehicle, the motorized battery lift rotatable about the vertical axis to rotationally align the robotic grippers with respect to the underside of the vehicle.

In one or more embodiments, the electric-vehicle service station further comprises an at least partially enclosed structure that includes first and second sidewalls that extend along a length of the vehicle lift and parallel to the first axis; and a roof attached to the first and second sidewalls. electric-vehicle service station the battery-storage apparatus is at least partially defined in the first or second sidewall.

Another aspect of the invention is directed to an electric-vehicle service station comprising: a first vehicle lift having a first platform and first motorized lifts that raise and lower the first platform, the first platform having a first service hole to expose an underside of a first electric vehicle; a second vehicle lift having a second platform and second motorized lifts that raise and lower the second platform, the second platform having a second service hole to expose an underside of a second electric vehicle, the first and second platforms having respective lengths measured with respect to a first axis; tracks that pass below the first and second platforms and into first and second service cavities defined by the first and second vehicle lifts, respectively, when the first and second platforms are in raised positions, the tracks extending along a second axis that is orthogonal to the first axis, the first and second axes orthogonal to a vertical axis with respect to which the first and second platforms are raised and lowered; a battery-storage apparatus between the first and second lifts, the tracks passing through a channel defined in the battery storage apparatus; a battery-exchange robot mounted on the tracks. The battery-exchange robot is configured to receive one or more first depleted batteries from the underside of the first electric vehicle and transport the one or more first depleted batteries to the battery-storage apparatus, receive one or more second depleted batteries from the underside of the second electric vehicle and transport the one or more second depleted batteries to the battery-storage apparatus, and receive one or more charged batteries from the battery-storage apparatus and transport the one or more charged batteries to the underside of the first or second electric vehicle.

### BRIEF DESCRIPTION OF THE DRAWINGS

For a fuller understanding of the nature and advantages of the concepts disclosed herein, reference is made to the detailed description of preferred embodiments and the accompanying drawings.

FIGS. 1 and 2 are side views of a system for automatically exchanging electric-vehicle batteries according to an embodiment.

FIG. 3 is a top view of the system illustrated in FIG. 1 with the vehicle removed.

FIG. 4 is a side view of the system illustrated in FIG. 1 where the telescoping arm of the battery-exchange robot is in an extended state.

FIG. 5 is an isolated isometric view of the battery-exchange robot illustrated in FIG. 1 where the cover of the battery receptacle is closed.

FIG. 6 is an isolated isometric view of the battery-exchange robot illustrated in FIG. 1 where the cover of the battery receptacle is opened.

FIG. 7 is a cross section of the battery receptacle illustrated in FIG. 5.

FIG. 8 is an isometric and isolated view of a motorized battery holding device according to an embodiment.

FIGS. 9 and 10 are top isolated views of the battery holding device illustrated in FIG. 8 where battery holding device is holding battery trays having different dimensions.

FIG. 11 is an isolated isometric view of the battery-exchange robot where the battery holding device is in a raised position.

FIG. 12 is a front view of an electric-vehicle service station where the retractable doors are opened according to an embodiment.

FIG. 13 is a front view of an electric-vehicle service station where the retractable doors are opened according to another embodiment.

FIG. 14 is a front view of the electric-vehicle service station illustrated in FIG. 12 where the retractable doors are closed according to an embodiment.

FIG. 15 is a front view of a side-by-side electric-vehicle service station where the retractable doors are opened according to an embodiment.

FIGS. 16A and 16B are front view of the side-by-side electric-vehicle service station illustrated in FIG. 15 where one of the retractable doors is closed and one of the retractable doors is opened according to an embodiment.

### DETAILED DESCRIPTION

A battery-exchange system for electric vehicles. The battery-exchange system includes a vehicle lift that can have an adjustable length with respect to a first axis to support electric vehicles have different lengths. The vehicle lift can be raised and lowered with motorized lifts. On- and off-ramps allow the electric vehicle to drive onto and off of the platform and to/from ground level.

When the vehicle lift is raised, a service cavity is defined beneath the platform. A service hole is defined along at least a portion of the length of the platform to expose the underside of the electric vehicle when the electric vehicle is positioned on the platform. A set of tracks extend between the service cavity and a battery-storage apparatus that holds charged electric-vehicle batteries. The tracks extend along a second axis that is orthogonal to the first axis and to a vertical axis along which the platform is raised and lowered.

A battery-exchange robot is mounted on the tracks and configured to move along the tracks between the service cavity and the battery-storage apparatus. The battery-exchange robot is configured to receive one or more depleted electric-vehicle batteries from the electric vehicle and transport the depleted electric-vehicle battery(ies) to the battery-storage apparatus where the depleted electric-vehicle battery(ies) can be charged. In addition, the battery-exchange robot is configured to receive one or more charged electric-vehicle batteries from the battery-storage apparatus and transport the charged electric-vehicle battery(ies) into the service cavity where the charged electric-vehicle battery(ies) can be attached to the underside of the electric vehicle.

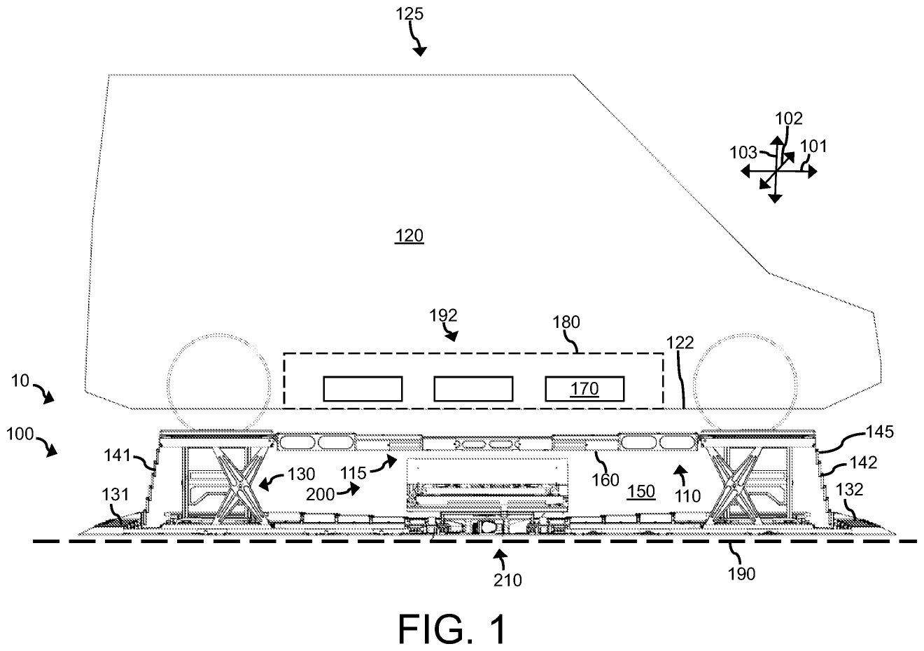

FIG. 1 is a side view of a system 10 for automatically exchanging electric-vehicle batteries according to an embodiment. The system 10 includes a vehicle lift 100 and a battery-exchange robot 200.

The vehicle lift 100 includes a platform 110 that lifts and supports an electric vehicle 120 to provide clearance for the battery-exchange robot 200 to access the underside of the electric vehicle 120. The platform 110 is mounted on motorized lifts 130 that can raise and lower (e.g., with respect to axis 103) the platform 110 including the electric vehicle 120. The vehicle lift 100 further includes an on-ramp 131 and an off-ramp 132 that allow the vehicle 120 to drive onto and off the platform 110, respectively, when the platform 110 is in a lowered position. The on-ramp 131 has an upward slope and extends from the ground 190 to the platform 110. The off-ramp 132 has a downward slope and extends from the platform 110 to the ground 190. The vehicle lift 100 can be supported by and/or placed on the ground 190.

First and second expandable walls 141, 142 are attached to the platform 110. The first expandable wall 141 is attached to the platform 110 and the on-ramp 131. The second expandable wall 142 is attached to the platform 110 and the off-ramp 132. In the raised position, the platform 110 and the expandable walls 141, 142 define a service cavity 150 for the battery-exchange robot 200 to operate. The vehicle lift 100 placed on the ground, a parking lot, or another surface 190.

In some embodiments, the length of the platform 110, the length of the on-ramp 131, and/or the length of the off-ramp 132 is/are adjustable. The lengths of the platform 110, the on-ramp 131, and the off-ramp 132 are measured along or with respect to a first axis 101. For example, each of the platform 110, the on-ramp 131, and/or the off-ramp 132 can include a plurality of stackable, overlapping, and/or nestable plates 160. In the illustrated embodiment, the platform 110 is an extended configuration (e.g., to accommodate a larger electric vehicle such as a delivery van or truck) and the on- and off-ramps 131, 132 are in contracted configurations.

The platform 110 and of the on- and off-ramps 131, 132 can be mechanically coupled such that their respective lengths are coupled. For example, when the platform 110 is in the extended configuration, the on- and off-ramps 131, 132 can be in contracted configurations. Conversely, when the platform 110 is in a contracted configuration, the on- and off-ramps 131, 132 can be in extended configurations. The coupling of the lengths of the platform 110 and of the on- and off-ramps 131, 132 can allow the length of the platform 110 to vary while maintaining the same overall length of the vehicle lift 10.

The expandable walls 141, 142 can include slats 145 that can be stacked, overlapped, and/or nested when the expandable walls 141, 142 are in contracted or lowered configurations. The expandable walls 141, 142 are illustrated in expanded or raised configurations. The expandable walls 141, 142 partially cover the service cavity 150 to prevent pedestrians from accessing the service cavity 150 to reduce potential injury from the battery-exchange robot 200. Additional details regarding the vehicle lift 100 are described in U.S. patent application Ser. No. 18/317,985, titled “Configurable Vehicle Lift and Service Station,” filed on May 16, 2023, which is hereby incorporated by reference.

The battery-exchange robot 200 is mounted on a set of track or rails 210 (in general, rails) that extend along or parallel to a second axis 102 that is orthogonal to the first axis. The rails 210 are preferably aligned with the middle 115 of the platform 110 so that the battery-exchange robot 200 is aligned with the middle 115 of the platform 110 and the middle 125 of the vehicle 120. The battery-exchange robot 200 is configured to access the underside 122 of the vehicle 120 where the batteries 170 for the vehicle 120 are mounted. The batteries 170 can held and/or enclosed in battery trays that can be releasably secured to the underside 122 of the vehicle 120, such as to an interface plate 180. The interface plate 180 is further described in U.S. Patent Application Publication No. 2022/0314769, titled “Interface for Coupling Electric Battery and Vehicle Systems,” published on Oct. 6, 2022, which is hereby incorporated by reference.

The battery-exchange robot 200 can receive and/or transport one or more depleted batteries 170 (e.g., in a battery tray) from the vehicle 120. In addition, the battery-exchange robot 200 can receive and/or transport one or more charged batteries 170 (e.g., in a battery tray) to the vehicle 120.

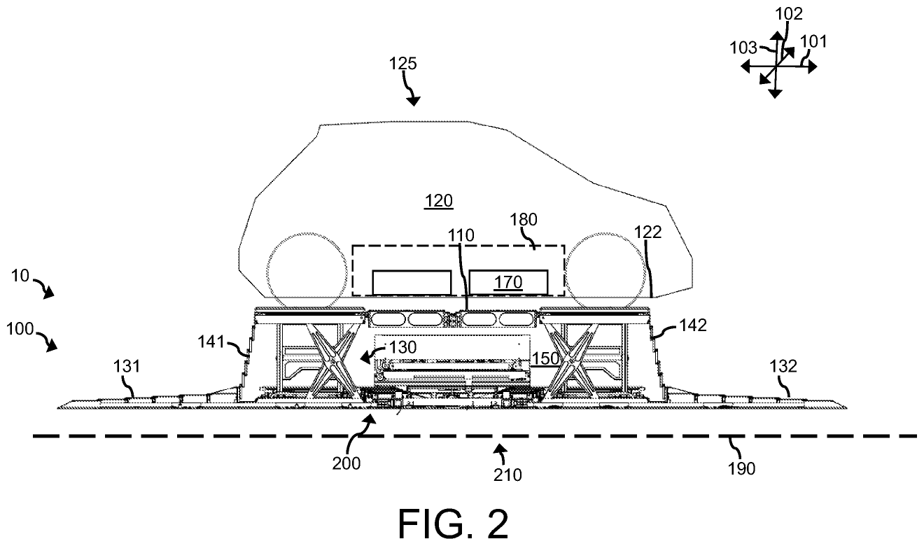

FIG. 2 illustrates an example of the platform 110 is a contracted configuration (e.g., to accommodate a smaller electric vehicle such as sedan) and the on- and off-ramps 131, 132 in extended configurations. Not all reference numbers from FIG. 1 are shown in FIG. 2.

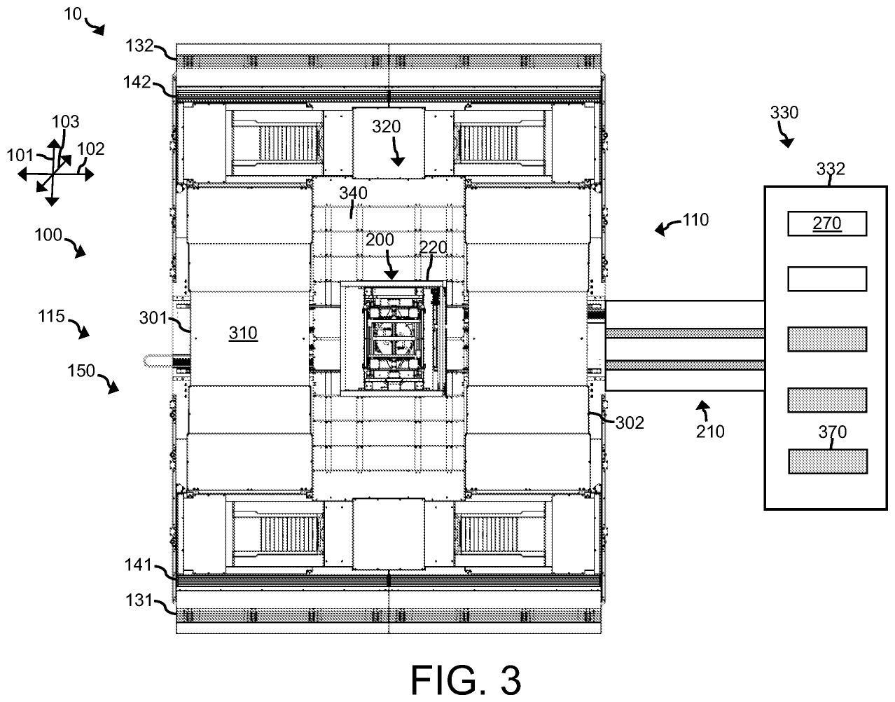

FIG. 3 is a top view of the system 10 with the vehicle 120 removed to further illustrate the platform 110 and the battery-exchange robot 200. The platform 110 includes first and second bridges 301, 302 that extend over the service cavity 150 when the platform 110 is raised. The bridges 301, 302 can include a plurality of stackable, overlapping, and/or nestable plates 310 that can allow the bridges 301, 302 to extend and contract, which can allow the platform 110 to extend and contract. The bridges 301, 302 are illustrated in the extended configuration. The bridges 301, 302 can be used to allow a vehicle to drive onto and off the platform 110. In addition, the bridges 301, 302 at least partially cover the service cavity 150 to prevent pedestrians from accessing the service cavity 150 to reduce potential injury from the battery-exchange robot 200. Bridges 301, 302 can also support pedestrians and can provide a pedestrian walkway for the pedestrians (e.g., drivers/passengers) to safely exit the vehicle during vehicle service even when the platform 100 is in the lifted position.

A service hole 320 is defined between the bridges 301, 302. The service hole 320 and the bridges 301, 302 extend along or parallel to the first axis 101. The length of the service hole 320 varies with the length of the bridges 301, 302. Expandable floor plates 340 can be placed on the bottom of the vehicle lift 100 to partially or fully cover the service hole 320 when the platform 110 is lowered. The floor plates 340 can slide with respect to each other to vary the length of the floor with respect to the first axis 101.

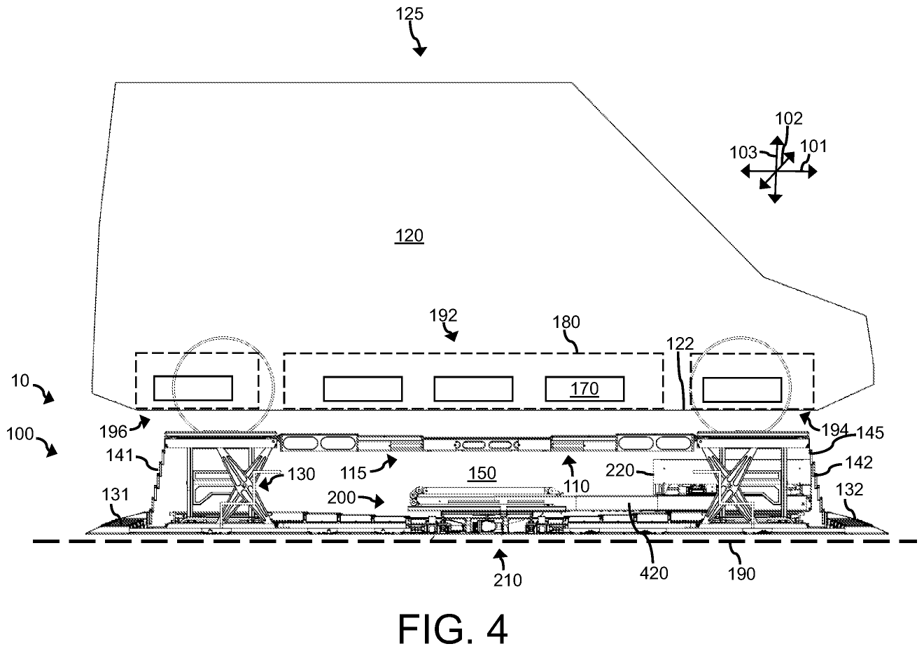

The battery-exchange robot 200 is positioned in the service cavity 150 and below the service hole 320. In this position, a battery receptacle 220 of the battery-exchange robot 200 can be raised, at the position of the battery-exchange robot 200, to engage a first portion 192 (FIG. 1) of the underbody 122 of the vehicle 120. Alternatively, one or more telescoping arms 420 can be extended along the length of the service hole 320, along or parallel to the first axis 101, to position the battery receptacle 220 beneath a second portion 194 of the underbody 122 of the vehicle 120, for example as illustrated in FIG. 4. The second portion 194 can correspond to a second portion of the interface plate 180 or another forward underbody 122 location where batteries may be secured to the vehicle 120.

The range of motion of the battery receptacle 220 is symmetric. For example, the battery receptacle 220 is illustrated as extending below the front wheels of the vehicle 120. The battery receptacle 220 preferably can extend to a third portion 196 below the rear wheels of the vehicle 120 to access any batteries secured to another rear underbody 122 location where batteries may be secured to the vehicle 120. The battery receptacle 220 can be positioned at any location between the first, second, and/or third portions 192, 194, 196, respectively.

Returning to FIG. 3, the rails 210 for the battery-exchange robot 200 can extend to a battery-storage apparatus 330 that can hold charged and/or depleted batteries 170. The battery-storage apparatus 330 includes a housing 332 to hold the batteries 170. For example, the battery-exchange robot 200 can receive and/or transport partially or fully depleted batteries that are removed from the vehicle and place these depleted batteries 270 in the battery-storage apparatus 330 to be charged. The depleted batteries 270 can be charged immediately or at a later time, for example during non-peak hours when it may be more cost-efficient. Additionally or alternatively, the battery-exchange robot 200 can receive and/or transport partially or fully charged batteries 370 from the battery-storage apparatus 330 to the vehicle to be attached or secured to the vehicle.

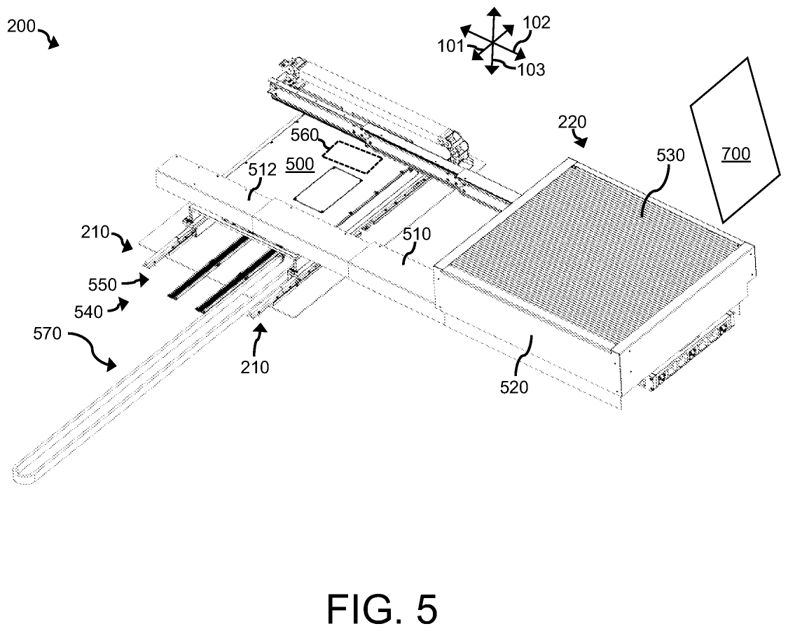

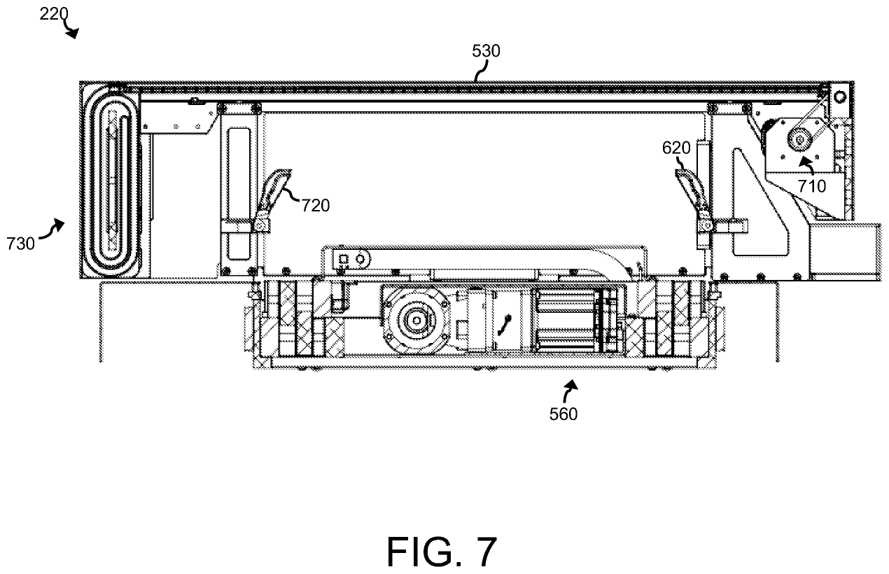

FIG. 5 is an isolated isometric view of the battery-exchange robot 200 according to an embodiment. The battery-exchange robot 200 includes a base 500, telescoping arms 510, and the battery receptacle 220. The base 500 is slidably mounted on the rails 210, which allows the battery-exchange robot 200 to move with respect the first axis 101. The base 500 is driven along the rails 210 with a servo belt drive system 540. The servo belt drive system 540 includes one or more servo belts 550 and a motor 560. The motor 560 is below the base 500 and is illustrated in dashed lines accordingly. The motor 560 is also illustrated in FIG. 7. A flexible energy chain 570 that houses the cables for (e.g., for power and control of) the battery-exchange robot 200 is also illustrated.

The telescoping arms 510 are mounted on the base 500. Each telescoping arm 510 includes a plurality of plates or segments 512 that can nest within one another when the telescoping arm 510 is contracted and slide away from each other (e.g., to partially overlap) when each telescoping arm 510 is extended. The telescoping arms 510 are illustrated in the extended configuration in FIGS. 3 and 4 and in the contracted configuration in FIGS. 1 and 2. The telescoping arms 510 can extend or contract with respect to the second axis 102. The telescoping arms 510 can be the same as telescoping arm(s) 420. The telescoping arms 510 can be driven using a chain-driven telescoping mechanism that includes timing belts, pulleys, and/or racks.

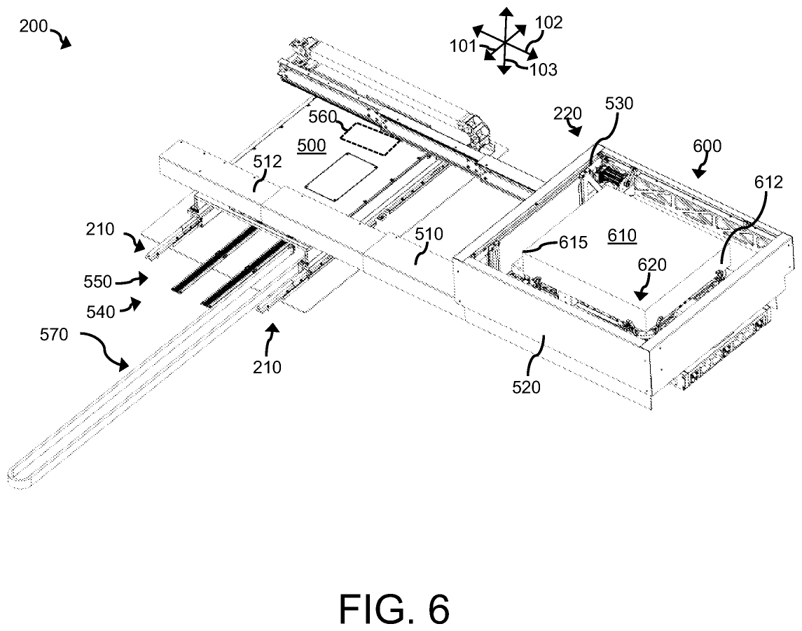

The battery receptacle 220 includes a housing 520 and a cover 530. The cover 530 is in a closed state in FIG. 5 and in an opened state in FIG. 6. The cover 530 can slide with respect to the second axis 102, for example as in an accordion cover, such that the cover 530 can contract and expand with respect to the second axis 102. The cover 530 protects against rain, snow, and/or debris from failing into the battery receptacle 220 (e.g., into cavity 600) and onto the battery tray and battery modules held in the battery receptacle 220.

When the cover 530 is opened, a cavity 600 defined in the housing 520 is revealed. The cavity 600 is configured to receive one or more batteries, which can be mounted on a battery tray 610 or on/in another housing. Alternatively, reference number 610 can refer to one or more batteries or one or more battery modules. A plurality of robotic grippers 620 can releasably secure or hold the battery tray/battery/module(s) (in general, battery tray) 610. The robotic grippers 620 can include robotic pincers, robotic fingers, and/or other grippers.

In operation, the cover 530 is configured to be in a default closed state. The cover 530 is configured to open when the battery receptacle 220 is positioned below the underside of the vehicle to receive a depleted electric-vehicle battery (e.g., in a battery tray) from the vehicle or to raise a charged electric-vehicle battery (e.g., in a battery tray) to the underside where the charged electric-vehicle battery is attached thereto. In addition, the cover 530 is configured to be opened to provide or receive electric-vehicle batteries to/from the battery-storage apparatus 330 (FIG. 3).

FIG. 7 is a cross section of the battery receptacle 220 through plane 700 in FIG. 5. A motorized belt drive 710 is configured to drive the removable cover 530 open and closed. The removable cover 530 is driven into and received by a spiral track 730. The cross section also illustrates that each robotic gripper 620 include a planar surface 720. The planar surfaces 720 are configured mechanically engage the planar sides 612 of the battery tray 610 such as near its corner 615, as illustrated in FIG. 6.

The motor 560 for the servo belt drive system 540, discussed above, is further illustrated in FIG. 7.

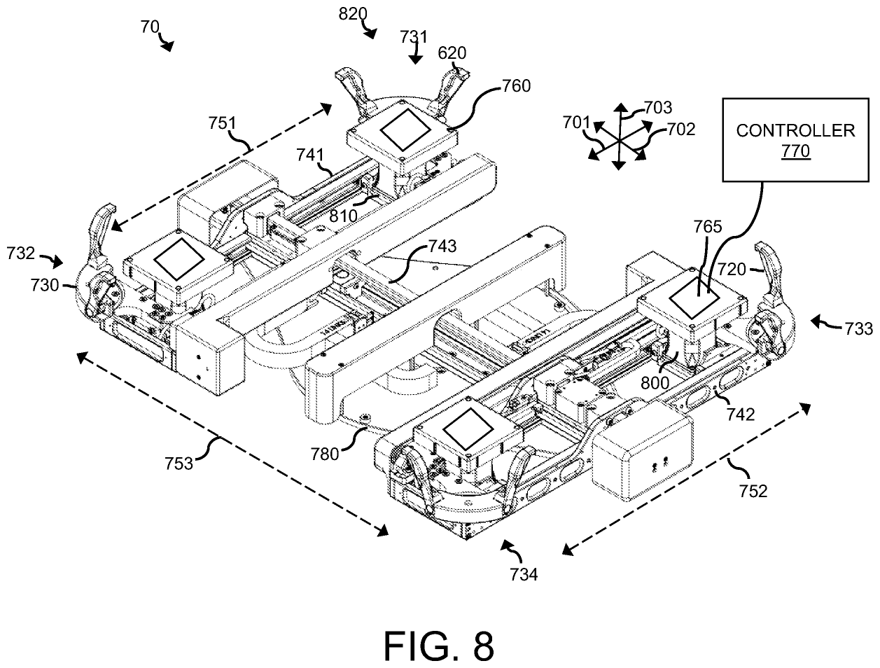

FIG. 8 is an isometric and isolated view of a motorized battery holding device 70 according to an embodiment. The battery holding device 70 includes the robotic grippers 620 and is located in the cavity 600 (FIG. 6) of the battery receptacle 220. The robotic grippers 620 are arranged in robotic-gripper pairs 820. Each robotic-gripper pair 820 is configured to releasably hold neighboring sides 612 of the battery tray 610, between a respective corner 615 of the battery tray 610, for example by applying force or pressure against the respective neighboring sides 612. The battery tray 610 can be replaced with a battery or a battery module.

Each robotic-gripper pair 820 is mounted on a respective robotic-gripper base 730. Each robotic-gripper base 730 is slidably mounted on a rail. Two robotic-gripper bases 731, 732 are slidably mounted on a first rail 741, and two robotic-gripper bases 733, 734 are slidably mounted on a second rail 742. The rails 741, 742 allow the robotic-gripper bases 730 to slide with respect to a first axis 701 to change the position of the robotic-gripper bases 730 and of the respective robotic-gripper pairs 820 with respect to the first axis 701.

For example, the robotic-gripper bases 731, 732 can slide inwardly (e.g., towards each other) along the first rail 741 to decrease the distance 751 between the robotic-gripper bases 731, 732 and the respective robotic grippers 620. Similarly, the robotic-gripper bases 733, 734 can slide inwardly (e.g., towards each other) along the second rail 742 to decrease the distance 752 between the robotic-gripper bases 733, 734 and the respective robotic grippers 620. The distances 751, 752 can vary with the dimensions of the battery tray 610, with respect to the first axis 701, so that the robotic grippers 620 are positioned to mechanically engage and releasably hold the sides 612 of the battery tray 610. In FIG. 7, the robotic-gripper bases 730 are positioned on the outside or end of the first and second rails 741, 742 to accommodate a battery tray 610 having maximum dimensions with respect to the first axis 701. Likewise, the distances 751, 752 can vary to release the sides 612 of the battery tray 610, for example when placing a depleted battery tray in the battery-storage device 330 (FIG. 3) or after a charged battery tray is secured to the underside of the vehicle.

The first and second rails 741, 742 are mounted on a center rail 743 that is oriented along or parallel to a second axis 702 that is orthogonal to the first axis 701. The first and second axes 701, 702 are orthogonal to a third axis 703. Axes 701-703 can be the same or different than axes 101-103, respectively. Axes 701-703 are preferably parallel to axes 101-103, respectively. The center rail 743 allows the first and second rails 741, 742 to be positioned with respect to the second axis 702 to change the position of the robotic-gripper bases 730 and of the respective robotic-gripper pairs 820. The center rail 743 can be or include a center track and/or multiple rails.

For example, the first and second rails 741, 742 can slide inwardly (e.g., towards each other) along the center rail 743 to decrease the distance 753 between the first and second rails 741, 742. Decreasing the distance 753 between the first and second rails 741, 742 causes a corresponding decrease in the distance between the robotic-gripper bases 731, 733 and in the distance between the robotic-gripper bases 732, 734. The distance 753 can vary with the dimensions of the battery tray 610, with respect to the second axis 702, so that the robotic grippers 620 are positioned to mechanically engage and releasably hold the sides 612 of the battery tray 610. In FIG. 7, the first and second rails 741, 742 are positioned on the outside or end of the first and center rail 743 to accommodate a battery tray 610 having maximum dimensions with respect to the second axis 702. The second rail is mounted on a base 780.

A pedestal 760 can be mounted next to each robotic-gripper base 730 to support a respective corner 615 of the battery tray 610. One or more sensors 765 can be disposed on or in each pedestal 760. The sensor(s) 765 can include an optical sensor to detect the presence and absence of the battery tray 610 on the pedestals 760. Additionally or alternatively, the sensor(s) 765 can include a force or pressure sensor. The force/pressure sensor can detect the presence and absence of the battery tray 610 on the pedestals and the force/pressure applied to the battery tray 610 and the respective pedestals 760 during battery exchange, for example when the battery tray 610 is raised onto a target location on the underside of the vehicle (e.g., onto the interface plate). A controller 770, in electrical communication with the sensors 765, can be configured to determine whether the force/pressure is approximately equal to and/or greater than a predetermined threshold pressure/force, which can indicate that the battery tray 610 is positioned correctly with respect to the underside of the vehicle.

In some embodiments, a respective spring 800 is attached to each pedestal 760 and a respective base 810. The springs 800 can allow at the vertical position of each pedestal 760 to vary. In some embodiments, the springs 800 can comprise or can be elastomeric lattice springs that allow for both compression (e.g. with respect to axis 703) and horizontal movement/sway (e.g., with respect to axis 701 and/or axis 702, e.g., the plane defined by axes 701 and 702).

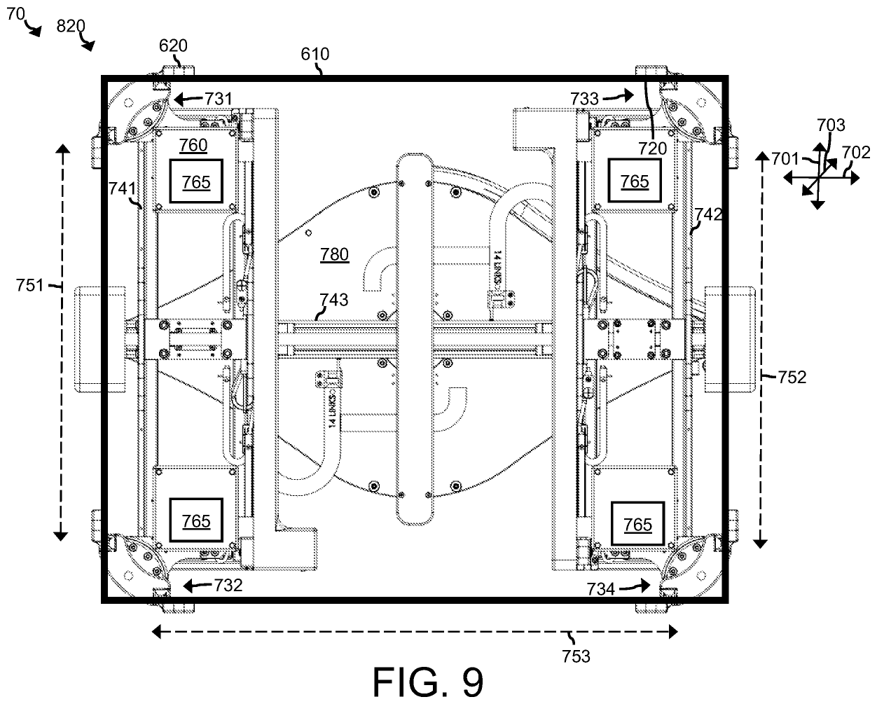

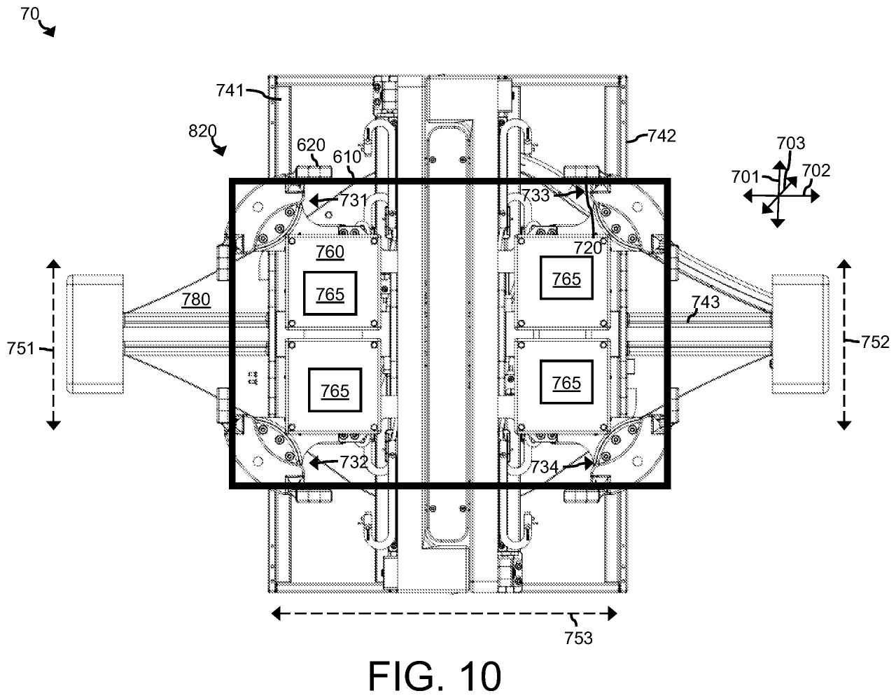

FIGS. 9 and 10 are top isolated views of the battery holding device 70 while holding battery trays 610 having different dimensions. In FIG. 9, the battery tray 610 has the maximum-allowable dimensions with respect to the first and second axes 701, 702. The battery holding device 70 is in the same configuration/state in FIG. 9 as in FIG. 8. In FIG. 10, the battery tray 610 has the minimum-allowable dimensions with respect to the first and second axes 701, 702. To hold a battery tray with these minimum-allowable dimensions, the robotic-gripper bases 731, 732 are located at the inward-most position along the first rail 741 and the robotic-gripper bases 733, 734 are located at the inward-most position along the second rail 742 to minimize the respective distances 751, 752. In addition, the first and second rails 741, 742 are located at the inward-most position along the center rail 743 to minimize the distance 753. For the purpose of FIGS. 9 and 10, the battery trays 610 are shown as transparent to illustrate the functionality of the battery holding device 70.

It is noted that the converse applies with respect to transitioning the battery holding device 70 from the minimum-dimension state/configuration in FIG. 9 to the maximum-dimension state/configuration in FIGS. 8 and 9. For example, the robotic-gripper bases 731, 732 can slide outwardly, from the minimum-dimension state/configuration in FIG. 10, along the first rail 741, and the robotic-gripper bases 733, 734 can slide outwardly, from the minimum-dimension state/configuration in FIG. 10, along the second rail 742, to maximize the respective distances 751, 752 (e.g., as illustrated in FIGS. 8 and 9). In addition, the first and second rails 741, 742 can slide outwardly from each other, from the minimum-dimension state/configuration in FIG. 10, along the center rail 743 to maximize the distance 753. The distances 751-753 can be set to any distance between the minimum-dimension state/configuration (FIG. 10) and the maximum-dimension state/configuration (FIGS. 8, 9).

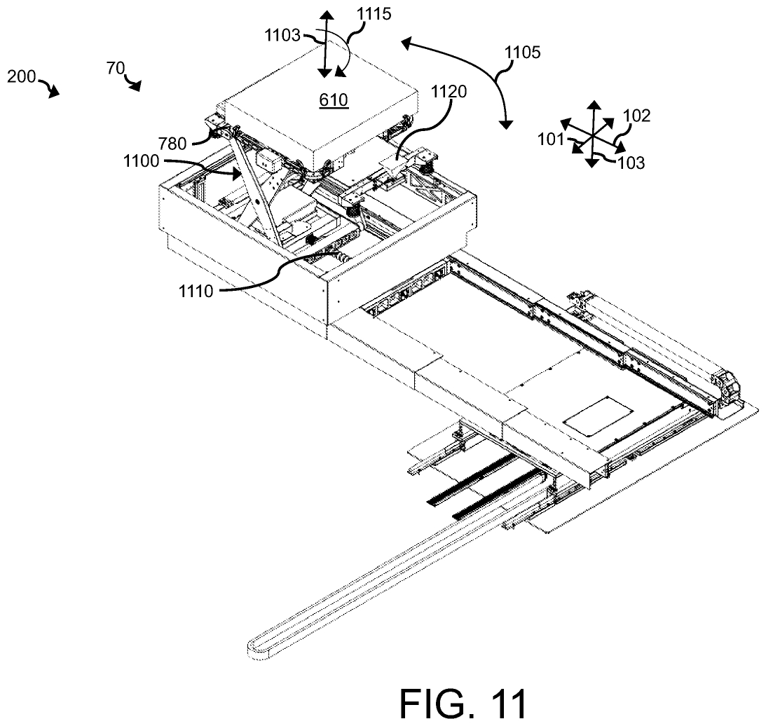

FIG. 11 is an isolated isometric view of the battery-exchange robot 200 where the battery holding device 70 is in a raised position. The battery holding device 70 is in a lowered position in FIGS. 8-10. A motorized battery lift 1100 is mechanically coupled to the base 780 of the battery holding device 70 to raise and lower the battery holding device 70 with respect to the third axis 103. When the battery holding device 70 is holding a battery tray 610, the battery tray 610 is raised and lowered with the battery holding device 70. The motorized battery lift 1100 can be driven by a lead screw 1110 that can be coupled to a motor. The motorized battery lift 1100 can be a scissor lift or another lift.

In some embodiments, the motorized battery lift 1100 can spin or rotate 1105 relative to the third axis 103 to rotationally position the robotic grippers 620 with respect to the underside of the vehicle. For example, the robotic grippers 620 can be rotationally positioned to receive a battery, battery tray, or battery module from the underside of the vehicle. In addition, when the robotic grippers 620 are holding a battery tray 610 (or a battery/battery module), the rotational positioning of the robotic grippers 620 also rotationally positions the battery tray 610 with respect to the underside of the vehicle (e.g., to be placed in the proper location) before raising the battery tray 610. In one example, the battery holding device 70 can spin or rotate about the third axis 103 (e.g., in the plane defined by the first and second axes 101, 102) and relative to the motorized battery lift 1100 such that the battery holding device 70 can spin 1115 (e.g., about a theta axis 1103 that is parallel to the third axis 103) while the motorized battery lift 1100 remains in the same position/orientation.

An optional optical sensor 1120 can be mounted on the battery holding device 70. The optical sensor 1120 can have line of sight to the underside of the vehicle and/or to the battery tray 610. In one example, the optical sensor 1120 can detect the position, configuration, and/or size of the interface plate, the battery trays and/or the battery-tray receptacles on the underside of the vehicle. Additionally or alternatively, the optical sensor 1120 can detect the battery tray 610 held by the battery holding device 70 during positioning into and/or retrieval from the underside of the vehicle. The optical sensor 1120 can comprise a camera, lidar, and/or another optical sensor.

To receive a depleted battery (e.g., a battery module, a battery tray) from an electric vehicle, the battery-exchange robot 200 is positioned along the rails 210 so that the battery-exchange robot 200 and the battery receptacle 220 are aligned, with respect to the second axis 102, with the depleted battery on the underside of the vehicle. The telescoping arm(s) 510 can be extended or retracted to align the battery receptacle 220, with respect to the first axis 101, with the depleted battery. Next, the cover 530 is opened and the relative positions of the robotic grippers 620 can be adjusted with respect to the axes 701, 702 according to the dimensions of the depleted battery. The motorized battery lift 1100 is then raised to lift the battery holding device 70 so that the robotic grippers 620 mechanically engage the sides of the depleted battery. When a threshold force or pressure is measured by the sensors 765, the battery-exchange robot 200 can send a command signal to the vehicle (e.g., a controller for the interface plate) to release the depleted battery, which is then received by the battery holding device 70. The motorized battery lift 1100 is then lowered and the cover 530 is closed to protect the depleted battery and the inside of the battery receptacle 220 during transport of the depleted battery to the battery-storage device.

To place a charged battery into the electric vehicle, the process is reversed. After a charged battery is received from the battery-storage device, the battery-exchange robot 200 is positioned along the rails 210 so that the battery-exchange robot 200 and the battery receptacle 220 are aligned, with respect to the second axis 102, with a target location (e.g., an open location on the interface plate) on the underside of the vehicle where the charged battery is to be placed. The telescoping arm(s) 510 can be extended or retracted to align the battery receptacle 220, with respect to the first axis 101, with the target location. Next, the cover 530 is opened and the motorized battery lift 1100 is raised to lift the battery holding device 70 while the charged battery is held by the robotic grippers 620 such that the charged battery is placed in the target location. When a threshold force or pressure is measured by the sensors 765, the battery-exchange robot 200 can send a command signal to the vehicle (e.g., to the interface plate controller) to secure the charged battery. The vehicle (e.g., the interface plate controller) can send a signal that indicates that the charged battery is secured. After the charged battery is secured (e.g., after receiving the signal from the vehicle such as the interface plate controller), the robotic grippers 620 mechanically disengage the charged battery (e.g., by moving the robotic grippers 620 with respect to the first and/or second axes 701, 702). The motorized battery lift 1100 is then lowered and the cover 530 is closed to protect the inside of the battery receptacle 220.

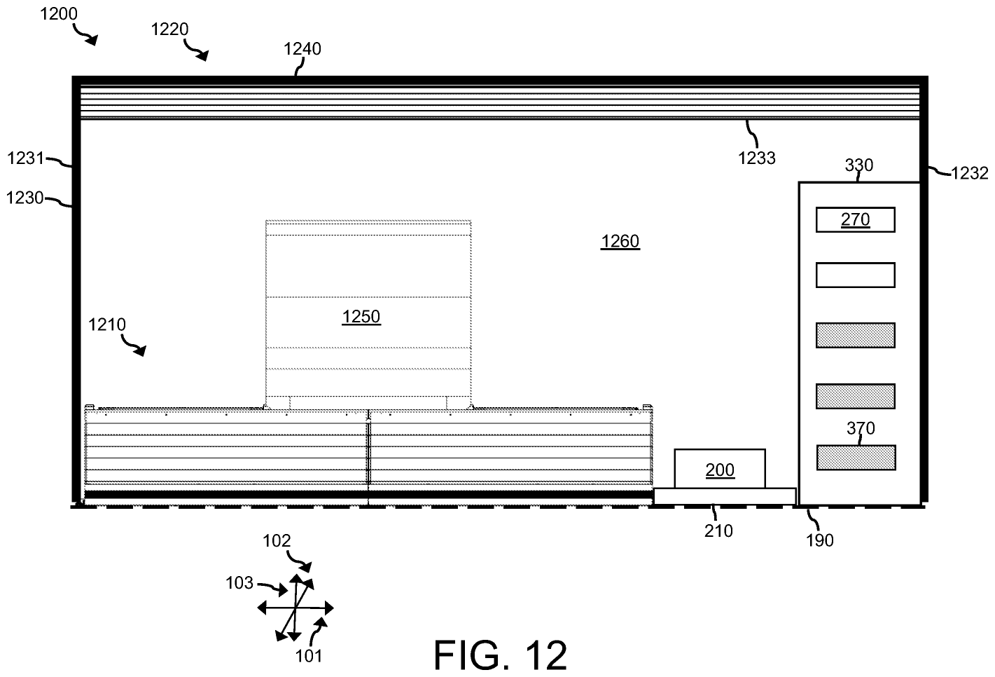

FIG. 12 is a front view of an electric-vehicle service station 1200 according to an embodiment. The service station 1200 is preferably an electric-vehicle service station. The service station 1200 can be transportable and can be placed on the ground or another surface 190.

The service station 1200 includes a vehicle lift 1210 and an at least partially enclosed structure 1220. The vehicle lift 1210 can be the same as vehicle lift 100. The structure 1220 includes a plurality of sidewalls 1230 and a roof 1240. The sidewalls 1230 include at least first and second sidewalls 1231, 1232 that extend along the length of the vehicle lift 1210 and along or parallel to the first axis 101. The roof 1240 extends over the vehicle lift 1210 and covers the vehicle lift 1210 along its length and width (e.g., with respect to the first and second axes 101, 102, respectively). The height of the roof 1240, as measured with respect to the third axis 103, is set to allow the vehicle lift 1210 to be in a raised state while supporting an electric vehicle 1250 without contacting the roof 1240. The height of the roof 1240 can be configured to accommodate a wide range of vehicles including sedans, large delivery vans, and other vehicles. The roof 1240 is configured to block rain, snow, and/or debris from passing into a service cavity 1260 defined by and within the structure 1220. The roof 1240 can also block the sun to reduce the temperature in the service cavity 1260.

The battery-exchange robot 200 can move along the rails 210 between the vehicle lift 1210 and the battery-storage apparatus 330. For example, the battery-exchange robot 200 can remove one or more discharged batteries (e.g., in one or more battery trays) from the underside of the vehicle 1250, transport the discharged battery(ies) to the battery-storage apparatus 330, and place the discharged battery(ies) in the battery-storage apparatus 330 to be charged. Additionally or alternatively, the battery-exchange robot 200 can receive one or more charged batteries (e.g., in one or more battery trays) that are removed from the battery-storage apparatus 330, transport the charged battery(ies) into the service cavity of the vehicle lift 1210, and lift the charged battery(ies) to the underside of the vehicle 1250 to attach the charged battery(ies) thereto.

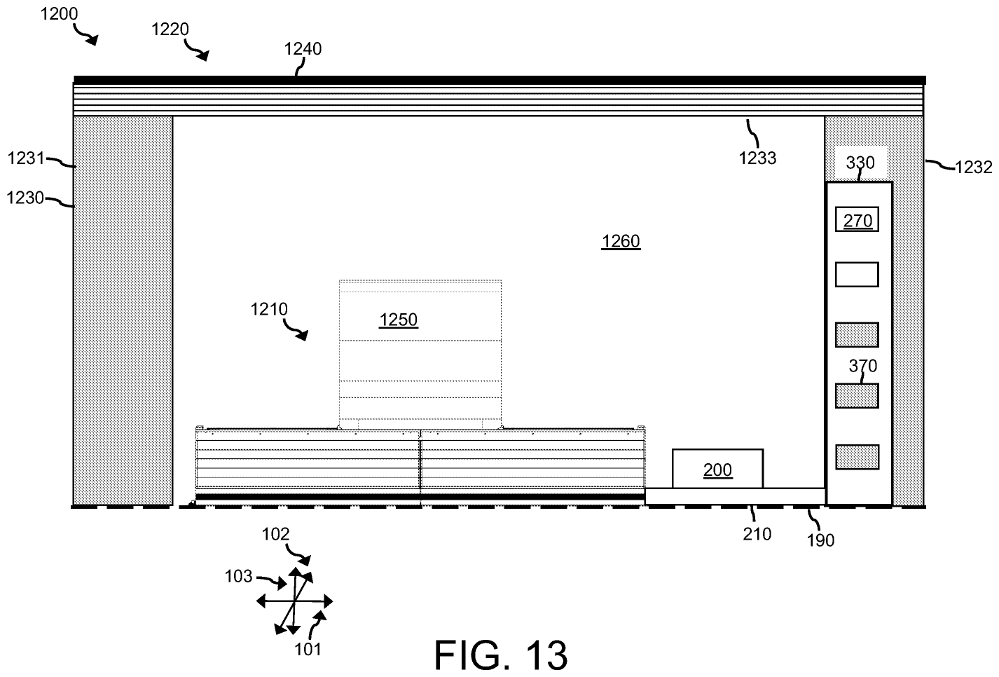

The battery-storage apparatus 330 can be at least partially defined in the second sidewall 1232. In an alternative embodiment, the battery-storage apparatus 330 can be at least partially defined in the first sidewall 1231. In another embodiment, the battery-storage apparatus 330 can be fully defined in one of the sidewalls, such as in the second sidewall 1232, as illustrated in FIG. 13.

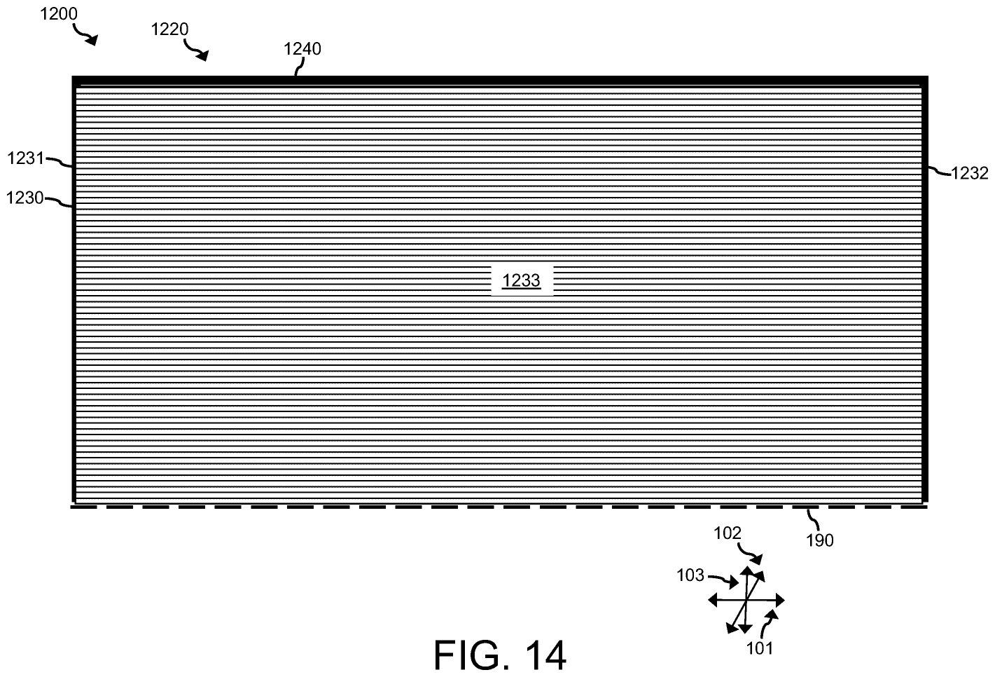

In some embodiments, the sidewalls 1230 include retractable doors 1233. The retractable doors 1233 can be opened to allow the vehicle 1250 to drive onto or off of the vehicle lift 1210, similar to an automatic garage door. The retractable doors 1233 can be closed after the vehicle 1250 drives onto the vehicle lift 1210 or when the service station 1210 is not in use (e.g., between vehicles, when the service station 1210 is closed, etc.). The retractable doors 1233 are opened in FIGS. 12 and 13 and closed in FIG. 14. The retractable door 1233 illustrated in the front views of FIGS. 12-14 is a front door. The other retractable door 1233, the back door, of the structure 1220 appears the same as the front door and is not illustrated for brevity.

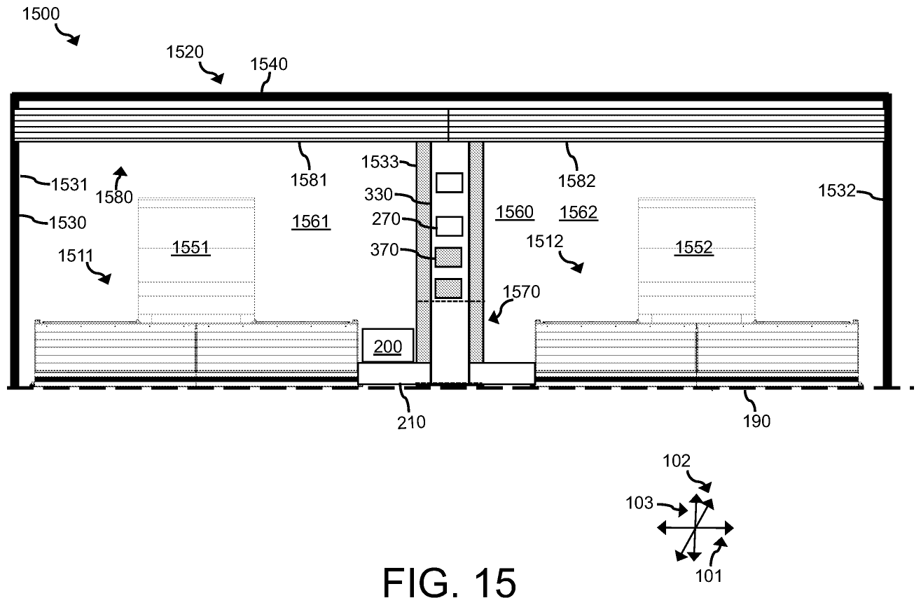

FIG. 15 is a front view of a side-by-side electric-vehicle service station 1500 according to an embodiment. The service station 1500 is preferably an electric-vehicle service station. The service station 1500 can be transportable and can be placed on the ground or another surface 190.

The service station 1500 includes first and second vehicle lifts 1511, 1512 and an at least partially enclosed structure 1520. Each vehicle lift 1511, 1512 can be the same as vehicle lift 100. The structure 1520 includes a plurality of sidewalls 1530 and a roof 1540. The sidewalls 1530 include at least first and second sidewalls 1531, 1532 that extend along the length of the service station 1500 (e.g., the length of the vehicle lifts 1511, 1512) and along or parallel to the first axis 101. The roof 1540 extends over the vehicle lifts 1511, 1512 and covers the vehicle lifts 1511, 1512 along its length and width (e.g., with respect to the first and second axes 101, 102, respectively). The height of the roof 1540, as measured with respect to the third axis 103, is set to allow the vehicle lifts 1511, 1512 to be in a raised state while supporting respective electric vehicles 1551, 1552 without contacting the roof 1540. The height of the roof 1540 can be configured to accommodate a wide range of vehicles including sedans, large delivery vans, and other vehicles. The roof 1540 is configured to block rain, snow, and/or debris from passing into a service cavity 1560 defined by and within the structure 1520. The roof 1540 can also block the sun to reduce the temperature in the service cavity 1560.

The battery-exchange robot 200 can move along the rails 210 between the first and second vehicle lifts 1511, 1512 and the battery-storage apparatus 330. A channel 1570 can be defined or formed in the battery-storage apparatus 330 to allow the battery-exchange robot 200 to pass through and between the first and second vehicle lifts 1511, 1512.

The battery-storage apparatus 330 can function as a wall or barrier between the first and second vehicle lifts 1511, 1512. For example, the battery-storage apparatus 330 can divide the service cavity 1560 into first and second service cavities 1561, 1562, respectively. The first vehicle lift 1511 and vehicle 1551 are located in the first service cavity 1561. The second vehicle lift 1512 and vehicle 1552 are located in the second service cavity 1562. Alternatively, the battery-storage apparatus 330 can be at least partially defined in a wall 1533 between the first and second vehicle lifts 1511, 1512. The channel 1570 can extend through some or all of the wall 1533.

The side-by-side configuration of service station 1500 can improve the efficiency and/or utilization of the battery-exchange robot 200 and/or of the battery-storage apparatus 330. For example, the battery-exchange robot 200 can receive one or more discharged batteries (e.g., in one or more battery trays) that is/are removed from the underside of the vehicle 1551, transport the discharged battery(ies) to the battery-storage apparatus 330, and place the discharged battery(ies) in the battery-storage apparatus 330 to be charged. In addition, the battery-exchange robot 200 can receive one or more discharged batteries (e.g., in one or more battery trays) that is/are removed from the underside of the vehicle 1552, transport the discharged battery(ies) to the battery-storage apparatus 330, and place the discharged battery(ies) in the battery-storage apparatus 330 to be charged.

Additionally or alternatively, the battery-exchange robot 200 can receive and/or remove one or more charged batteries (e.g., in one or more battery trays) from the battery-storage apparatus 330, transport the charged battery(ies) into the service cavity of the first vehicle lift 1551, and lift the charged battery(ies) to the underside of the vehicle 1551 where the charged battery(ies) are attached thereto. In addition, the battery-exchange robot 200 can receive and/or remove one or more charged batteries (e.g., in one or more battery trays) from the battery-storage apparatus 330, transport the charged battery(ies) into the service cavity of the second vehicle lift 1552, and lift the charged battery(ies) to the underside of the vehicle 1552 where the charged battery(ies) are attached thereto.

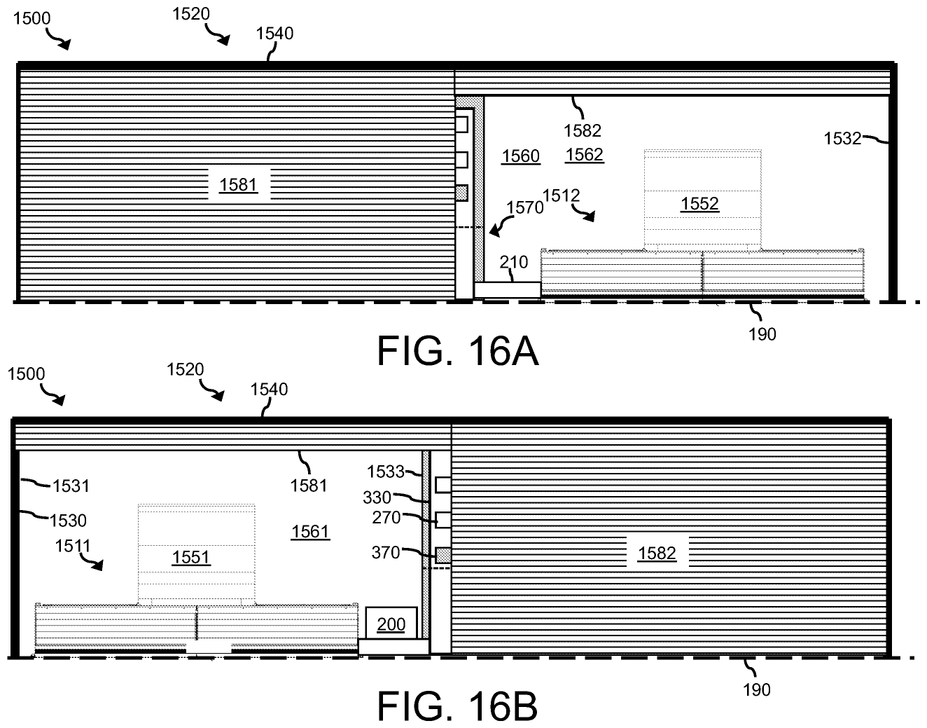

In some embodiments, the sidewalls 1530 include retractable doors 1580. In one example, a first retractable door 1581 can be opened to allow vehicle 1551 to drive onto the first vehicle lift 1511. A second retractable door 1582 can be opened to allow vehicle 1552 to drive onto the second vehicle lift 1512. The first and second retractable doors 1581, 1582 can preferably open and close independently. Each retractable door 1581, 1582 can be closed after the respective vehicle 1551, 1552 drives onto the respective vehicle lift 1511, 1512 or when the respective vehicle lift 1511, 1512 is not in use (e.g., between vehicles, when the service station 1500 is closed, when the respective vehicle lift 1511, 1512 is closed, etc.). The retractable doors 1581, 1582 are opened in FIG. 15. The first retractable door 1511 is closed and the second retractable door 1512 is opened in FIG. 16A. The first retractable door 1511 is opened and the second retractable door 1512 is closed in FIG. 16B.

The retractable doors 1511, 1512 illustrated in the front views of FIGS. 15 and 16A-B are front doors. The structure 1520 can also include first and second back doors that appear the same as the respective front doors and are not illustrated for brevity.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system for exchanging electric-vehicle batteries, comprising:
a vehicle lift having a platform that supports and lifts an electric vehicle from a lowered position to a raised position, the platform having a length measured with respect to a first axis, the platform having a service hole to expose an underside of the electric vehicle;
tracks that pass below the platform and into a service cavity defined by the vehicle lift when the platform is in the raised position, the tracks extending along a second axis that is orthogonal to the first axis, the first and second axes orthogonal to a vertical axis along which the platform is raised and lowered; and
a battery-exchange robot comprising:
a base mounted on the tracks;
a battery receptacle configured to hold one or more batteries; and
a telescoping arm attached to the base and the battery receptacle, the telescoping arm configured to extend and contract with respect to the first axis to position the battery receptacle with respect to the underside of the vehicle.

2. The system of claim 1, further comprising a battery-storage apparatus, the tracks extending to the battery storage apparatus.

3. The system of claim 2, wherein the battery-exchange robot is configured to receive and transport one or more depleted batteries from the electric vehicle to the battery-storage apparatus.

4. The system of claim 3, wherein the battery-exchange robot is configured to and transport one or more charged batteries from the battery-storage apparatus to the electric vehicle.

5. The system of claim 4, wherein the one or more depleted batteries and the one or more charged batteries are enclosed in respective battery trays.

6. The system of claim 1, wherein the battery receptacle comprises:
a cover;
a housing defining a cavity; and
a motorized battery holding device in the cavity.

7. The system of claim 6, wherein the motorized battery holding device includes a plurality of robotic grippers, each robotic gripper configured to releasably hold a side of a battery tray that includes the one or more batteries.

8. The system of claim 7, wherein:
each robotic gripper includes a respective planar surface,
the battery tray includes planar sides, and
the respective planar surface of each robotic gripper mechanically engages one of the planar sides of the battery tray.

9. The system of claim 8, wherein:
the robotic grippers are arranged into a plurality of robotic-gripper pairs,
each robotic-gripper pair includes first and second robotic grippers that are configured to mechanically engage neighboring sides of the battery tray, a respective corner of the battery tray between the first and second robotic grippers of each robotic-gripper pair,
first and second robotic-gripper pairs are slidably mounted on a first rail,
third and fourth robotic-gripper pairs are slidably mounted on a second rail, the first and second rails extending parallel to the first axis, and
respective positions of the first, second, third, and fourth robotic-gripper pairs with respect to the first axis are variable.

10. The system of claim 9, wherein:
the first and second rails are slidably mounted on a center rail that extends parallel to the second axis,
the respective positions of the first and second robotic-gripper pairs with respect to the second axis are variable by moving the first rail along the center rail, and
the respective positions of the third and fourth robotic-gripper pairs with respect to the second axis are variable by moving the second rail along the center rail.

11. The system of claim 10, wherein the motorized battery holding device further includes a motorized lift to raise and lower the first, second, and center rails to thereby raise and lower the robotic grippers.

12. The system of claim 11, wherein the cover has a default closed state, the cover configured to transition to an opened state in order for the battery receptacle to remove the battery tray from the vehicle or to provide the battery tray to the vehicle.

13. An electric-vehicle service station comprising:
a vehicle lift having a platform and a plurality of motorized lifts that raise and lower the platform, the platform having an adjustable length, measured with respect to a first axis, to support electric vehicles of different sizes, the platform having a service hole to expose an underside of the electric vehicle;
an upwardly sloped on-ramp disposed between ground level and the platform;
a downwardly sloped off-ramp disposed between the platform and ground level;
tracks that pass below the platform and into a service cavity defined by the vehicle lift when the platform is in a raised position, the tracks extending along a second axis that is orthogonal to the first axis, the first and second axes orthogonal to a vertical axis along which the platform is raised and lowered;
a battery-storage apparatus, the tracks extending to the battery storage apparatus; and
a battery-exchange robot mounted on the tracks, the battery-exchange robot configured to:
receive one or more depleted batteries from the underside of the electric vehicle and transport the one or more depleted batteries to the battery-storage apparatus to be charged, and
receive one or more charged batteries from the battery-storage apparatus and transport the one or more charged batteries to the underside of the electric vehicle.

14. The electric-vehicle service station of claim 13, wherein the battery-exchange robot comprises:
a base mounted on the tracks;
a battery receptacle that holds, at different times, the one or more depleted batteries and the one or more charged batteries; and
a telescoping arm attached to the base and the battery receptacle, the telescoping arm configured to extend and contract with respect to the first axis to position the battery receptacle with respect to the underside of the vehicle.

15. The electric-vehicle service station of claim 14, wherein the battery receptacle comprises:
a cover;
a housing defining a cavity; and
a motorized battery holding device in the cavity, the motorized battery holding device includes a plurality of robotic grippers that releasably hold an electric-vehicle battery.

16. The electric-vehicle service station of claim 15, wherein the motorized battery holding device further comprises:
a plurality of pedestals that support the electric-vehicle battery; and
a plurality of pressure sensors, each pressure sensor disposed on a respective pedestal.

17. The electric-vehicle service station of claim 15, wherein the motorized battery holding device further comprises a motorized battery lift that raises and lowers the robotic grippers towards and away from the underside of the vehicle, the motorized battery lift rotatable about the vertical axis to rotationally align the robotic grippers with respect to the underside of the vehicle.

18. The electric-vehicle service station of claim 13, further compromising an at least partially enclosed structure that includes:
first and second sidewalls that extend along a length of the vehicle lift and parallel to the first axis; and
a roof attached to the first and second sidewalls.

19. The electric-vehicle service station of claim 18, wherein the battery-storage apparatus is at least partially defined in the first or second sidewall.

20. An electric-vehicle service station comprising:
a first vehicle lift having a first platform and first motorized lifts that raise and lower the first platform, the first platform having a first service hole to expose an underside of a first electric vehicle;
a second vehicle lift having a second platform and second motorized lifts that raise and lower the second platform, the second platform having a second service hole to expose an underside of a second electric vehicle, the first and second platforms having respective lengths measured with respect to a first axis;
tracks that pass below the first and second platforms and into first and second service cavities defined by the first and second vehicle lifts, respectively, when the first and second platforms are in raised positions, the tracks extending along a second axis that is orthogonal to the first axis, the first and second axes orthogonal to a vertical axis with respect to which the first and second platforms are raised and lowered;
a battery-storage apparatus between the first and second lifts, the tracks passing through a channel defined in the battery storage apparatus; and
a battery-exchange robot mounted on the tracks, the battery-exchange robot configured to:
receive one or more first depleted batteries from the underside of the first electric vehicle and transport the one or more first depleted batteries to the battery-storage apparatus,
receive one or more second depleted batteries from the underside of the second electric vehicle and transport the one or more second depleted batteries to the battery-storage apparatus, and
receive one or more charged batteries from the battery-storage apparatus and transport the one or more charged batteries to the underside of the first or second electric vehicle.
